(19) United States
(12) Patent Application Publication
(10) Pub. No.: US 2026/0047611 A1
(43) Pub. Date: Feb. 19, 2026

(54) AEROSOL GENERATING DEVICE

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 19/103,191

(22) PCT Filed: Aug. 10, 2023
(86) PCT No.: PCT/KR2023/011885

§ 371 Date: Feb. 11, 2025

(30) Foreign Application Priority Data
Aug. 17, 2022 (KR) 10-2022-0102408
Oct. 12, 2022 (KR) 10-2022-0130926

(51) Int. Cl. A24F 40/46; A24F 40/20; A24F 40/51; A24F 40/57; A24F 40/60

(52) U.S. Cl. CPC A24F 40/46; A24F 40/20; A24F 40/51; A24F 40/57; A24F 40/60

(57) ABSTRACT

An aerosol generating device is disclosed. The aerosol generating device includes: a body comprising a first opening to a first insertion space; a heater module configured to be removably inserted into the first insertion space, wherein the heater module comprises: a heater holder comprising a second opening to a second insertion space, wherein a heater is disposed in the second insertion space, a frame coupled to the heater holder, and a substrate coupled to the frame and on which a memory configured to store unique information regarding the heater is mounted; and a controller disposed in the body and configured to control operation of the heater based on receiving the unique information regarding the heater from the memory.

### TECHNICAL FIELD

The present disclosure relates to an aerosol generating device.

### BACKGROUND ART

An aerosol generating device is a device that extracts certain components from a medium or a substance by forming an aerosol. The medium may contain a multi-component substance. The substance contained in the medium may be a multi-component flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to accurately calculate the temperature of a heater.

It is yet another objective of the present disclosure to precisely control components, including a heater, of an aerosol generating device.

It is yet another objective of the present disclosure to facilitate cleaning of a heater module.

It is yet another objective of the present disclosure to facilitate the replacement of a heater.

### Solution to Problem

According to an aspect of the subject matter described in this application, an aerosol generating device includes: a body comprising a first opening to a first insertion space; a heater module configured to be removably inserted into the first insertion space, wherein the heater module comprises: a heater holder comprising a second opening to a second insertion space, wherein a heater is disposed in the second insertion space, a frame coupled to the heater holder, and a substrate coupled to the frame and on which a memory configured to store unique information regarding the heater is mounted; and a controller disposed in the body and configured to control operation of the heater based on receiving the unique information regarding the heater from the memory.

### Advantageous Effects of Invention

According to at least one of the embodiments of the present disclosure, the temperature of a heater can be accurately calculated.

According to at least one of the embodiments of the present disclosure, components, including a heater, of an aerosol generating device can be precisely controlled.

According to at least one of the embodiments of the present disclosure, cleaning of a heater module can be facilitated.

According to at least one of the embodiments of the present disclosure, the replacement of a heater can be achieved in an easier manner.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 20 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

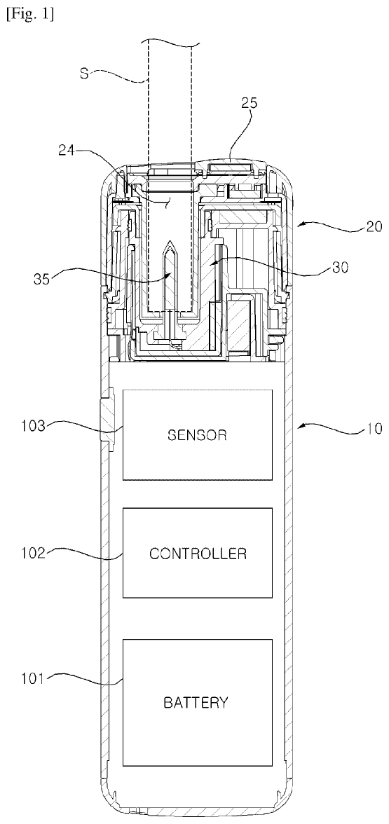

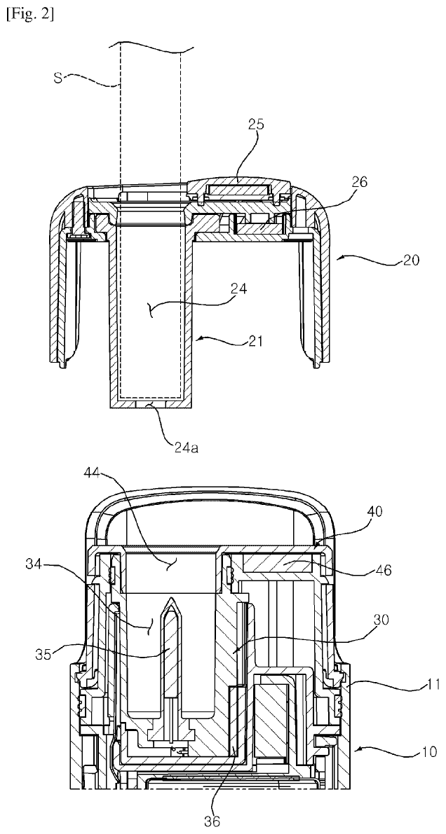

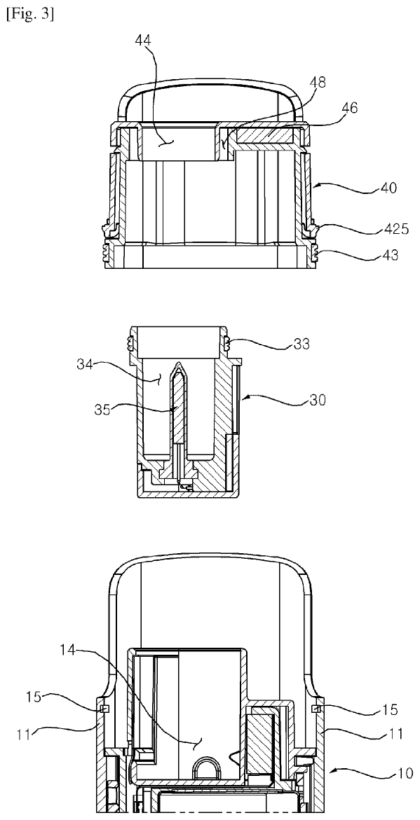

Referring to FIGS. 1 to 3, an aerosol generating device may include at least one of a body 10, an outer cover 20, a heater module 30, and an inner cover 40. The body 10 may accommodate therein at least one of a battery 101, a controller 102, and a sensor 103. The body 10 may have therein a first insertion space 14 open at top. The first insertion space 14 may be formed at an upper portion of the body 10.

The heater module 30 may be detachably inserted into the first insertion space 14. The heater module 30 may have therein a second insertion space 34 open at top. The second insertion space 34 may be elongated vertically. A heater 35 may be fixed to the heater module 30. The heater 35 may protrude upward from a lower portion of the second insertion space 34. The heater 35 may heat around the second insertion space 34.

The outer cover 20 may be detachably coupled on top of the body 10. The outer cover 20 may cover the upper portion of the body 10 and the heater module 30. The outer cover 20 may include an extractor 21. The extractor 21 may have therein a third insertion space 24 open at top. The extractor 21 and the third insertion space 24 may have a vertically elongated shape. The extractor 21 may be inserted into the second insertion space 34 inside the heater module 30. When the extractor 21 is inserted into the second insertion space 34, the heater 35 may be exposed to the third insertion space 24 through a through-hole 24a open at a bottom of the extractor 21. A cap 25 may be movably coupled to the outer cover 20 to open and close the opening of the third insertion space 24.

A first magnet 26 may be provided in the outer cover 20. As an attractive force is exerted between the first magnet 26 and a second magnet 46 provided in the inner cover 40, the outer cover 20 may be detachably coupled on top of the inner cover 40.

A stick S may be inserted into the third insertion space 24 to be supported by the extractor 21. The heater 35 may be inserted into the stick S that is inserted into the third insertion space 24. The heater 35 may heat the third insertion space 24 and the stick S to generate an aerosol. When the outer cover 20 is removed from the body 10, the stick S inside the extractor 21 may also be separated from the body 10 and extracted. Thus, the stick S may be easily removed.

The inner cover 40 may be disposed between the body 10 and the outer cover 20. The inner cover 40 may be detachably coupled to the body 10. The inner cover 40 may cover the upper portion of the body 10 and the heater module 30. The inner cover 40 may be detachably coupled to an upper portion of the heater module 30. When the inner cover 40 is removed from the body 10, the heater module 30 may be separated from the first insertion space 14. Accordingly, the heater module 30 may be easily removed from the body 10, allowing the heater module 30 to be more easily replaced.

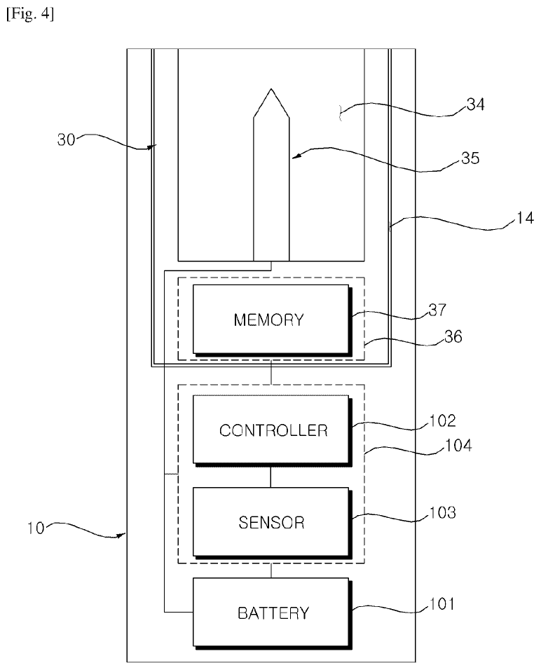

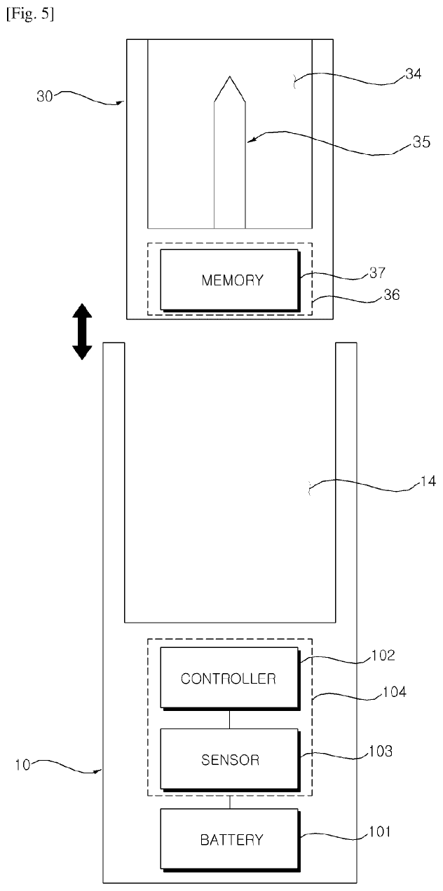

Referring to FIGS. 4 and 5, the aerosol generating device may include at least one of a battery 101, a controller 102, and a sensor 103. At least one of the battery 101, the controller 102, and the sensor 103 may be accommodated in a body 10 of the aerosol generating device. The body 10 may have a vertically elongated shape. The controller 102 and the sensor 103 may be mounted on a first substrate 104 disposed in the body 10. The controller 102 and the sensor 103 may be mounted together on a single first substrate 104. Alternatively, the function of the sensor 103 may be embedded in the controller 102.

The battery 101 may supply power to operate components of the aerosol generating device. The battery 101 may supply power to at least one of the controller 102, the sensor 103, a heater 35, and a memory 37. The battery 101 may supply power required to operate various components, such as an induction coil (not shown), a user interface, and the like, installed at the aerosol generating device.

The controller 102 may control the overall operation of the aerosol generating device. The controller 102 may control the operation of at least one of the battery 101, the sensor 103, the heater 35, and the memory 37. The controller 102 may receive information from the sensor 103. The controller 102 may control the operation of an induction coil (not shown), a user interface, and the like installed at the aerosol generating device. The controller 102 may check the state of each of the components of the aerosol generating device to determine whether the aerosol generating device is in an operable state.

A heater module 30 may be detachably coupled to an upper side of the body 10. For example, the heater module 30 and the body 10 may be coupled together by a magnetic force, in a snap-fit manner, or by a screw. The heater module 30 may have a second insertion space 34 open at top. The second insertion space 34 may have an elongated cylindrical shape. The body 10 may have a first insertion space 14 into which the heater module 30 is detachably inserted. The first insertion space 14 may be formed at an upper portion of the body 10, and may be open at top.

The heater module 30 may include the heater 35. The heater 35 may heat the second insertion space 34. For example, the heater 35 may protrude from a bottom of the second insertion space 34 toward the opening of the second insertion space 34 in an upwardly tapered shape. As another example, the heater 35 may have a cylindrical shape surrounding the second insertion space 34.

A stick S may be inserted into the second insertion space 34 formed in the heater module 30. The stick S may have an elongated cylindrical shape. A lower end of the stick S may be inserted into the second insertion space 34, and an upper end of the stick S may protrude out of the aerosol generating device from the second insertion space 34. When the stick S is inserted into the second insertion space 34, the heater 35 may be inserted into the stick S. A user may inhale air while holding the upper end of the stick S exposed to the outside in his or her mouth. The heater 35 may heat the stick S inserted into the second insertion space 34. When the stick S is heated to a predetermined temperature by the heater 35, an aerosol may be generated from the stick S.

The heater 35 may be a resistive heater. The heater 35 may include a variable resistance metal. The heater 35 may generate heat using power received from the battery 101. Alternatively, the heater 35 may generate heat using an eddy current generated by a magnetic field produced by an induction coil (not shown) surrounding the heater 35.

The heater 35 may have unique (or specific) information. The unique information of the heater 35, which is a parameter related to an intrinsic property of the heater 35, may be a parameter for determining a voltage applied to the heater 35. For example, the unique information of the heater 35 may include parameters related to the intrinsic property of the heater 35 that affect the heating operation of the heater 35, such as a specific resistance value of the heater 35, a temperature coefficient of resistance (TCR) value (hereinafter referred to as a “TCR value”) of the heater 35, an inductance value of the heater 35, a capacitance value of the heater 35, etc. The resistance value of the heater 35 may vary with temperature. When the temperature rises as the heater 35 generates heat, the resistance value of the heater 35 may increase. The resistance value at a specific temperature may vary depending on the specific resistance value and the TCR value of the heater 35.

The sensor 103 may detect a value related to the temperature of the heater 35 or a value related to the resistance of the heater 35. For example, the sensor 103 may detect a voltage value applied to the heater 35. For example, the sensor 103 may detect a current value flowing through the heater 35.

The controller 102 may receive a value detected by the sensor 103. The controller 102 may estimate the temperature of the heater 35 based on the value received from the sensor 103. For example, since the resistance value of the heater 35 varies according to the temperature of the heater 35, the controller 102 may calculate the resistance value of the heater 35 based on a current value received from the sensor 103 to determine the temperature of the heater 35. As another example, the controller 102 may receive a temperature value of the heater 35 detected by the sensor 103 to determine the temperature of the heater 35.

The unique information of the heater 35 may vary depending on the material properties of the heater 35, but may also be slightly affected, for example, by dimensional errors in shape, such as the length and thickness of a heating wire of the heater 35, which may occur during manufacturing. As another example, errors in the proportions of the components constituting an alloy of the heater 35, which may occur during manufacturing, may also affect the unique information of the heater 35. These are merely examples, and the factors that affect the unique information of the heater 35 are not limited thereto. Due to these factors, a difference between an estimated temperature of the heater 35 and an actual temperature of the heater 35 may occur, thereby leading to inaccurate control.

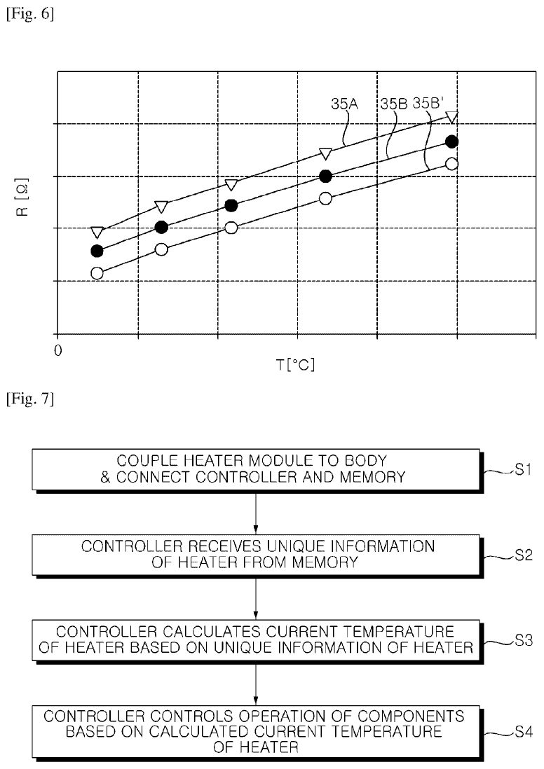

FIG. 6 is a graph showing a relationship between the resistance and the temperature of heaters having different TCR values. For example, referring to FIG. 6, a first heater 35A and a second heater 35B, which are made of the same material, may have slightly different specific resistance values and TCR values, due to an error in the ratio of an alloy occurred during the manufacturing process. As another example, due to contact of foreign matter with a heat wire of the second heater 35B, a lead wire 359, a first substrate 104 on which the controller 102 is mounted, or due to internal and external noise, the TCR value of the second heater 35B may be determined as a TCR value of a third heater 35B′.

Therefore, the resistance value of the heater 35 at a specific temperature of the heater 35 may be different for the first heater 35A, the second heater 35B, and the third heater 35B′. As a result, an error in resistance value calculated by the controller 102 may occur, which may cause an error in calculating the temperature of the heater 35.

In order to solve this problem, the heater module 30 may include a memory 37. The memory 37 may be mounted on a second substrate 26 installed in the heater module 30. The memory 37 may store unique (or specific) information of the heater 35 included in the heater module 30.

For example, the memory 37 may store therein a specific resistance value or a TCR value of the heater 35 included in the heater module 30. Upon the manufacture of the heater module 30, an exact unique parameter of each manufactured heater 35 may be measured by an external measuring device to be stored in the memory 37. Due to these reasons, memories 37 included in respective heater modules 30 may store therein different specific resistance values of the heater 35 from each other.

The controller 102 may store information corresponding to a plurality of heater parameters. For example, the controller 102 may store temperature (T)-resistance value (R) curve information for each heater parameter (see FIG. 6). For example, the controller 102 may store information corresponding to the plurality of heater parameters in the form of a look-up table. The controller 102 may receive unique information regarding the heater 35 from the memory 37 included in the heater module 30 to match the unique information regarding the heater 35 with any one of the stored plurality of heater parameters. For example, the controller 102 may match the received unique information regarding the heater 35 with a specific heater parameter on a temperature (T)-resistance value (R) curve.

Referring to FIG. 7, when the heater module 30 is coupled to the body 10, the heater 35 may be electrically connected to at least one of the battery 101, the controller 102, and the sensor 103 (see step S1 in FIG. 7). When the heater module 30 is coupled to the body 10, the memory 37 may be electrically connected to at least one of the battery 101 and the controller 102 (see step S1 in FIG. 7). When the heater module 30 is removed from the body 10, the heater 35 may be separated from the battery 101, the controller 102, and the sensor 103. When the heater module 30 is removed from the body 10, the memory 37 may be separated from the battery 101 and the controller 102.

The controller 102 may receive unique information of the heater 35 from the memory 37 (see step S2 in FIG. 7). For example, the controller 102 may receive a specific resistance value of the heater 35 from the memory 37. For example, the controller 102 may receive a specific TCR value of the heater 35 from the memory 37. However, these are merely examples, and the present disclosure is not limited thereto. The controller 102 may receive various unique information of the heater 35 for estimating the temperature of the heater 35.

The controller 102 may calculate the temperature of the heater 35 based on the unique information of the heater 35 (see step S3 in FIG. 7). For example, referring to FIG. 6, the controller 102 may receive a TCR value of the heater 35 corresponding to the first heater 35A from the memory 37, and receive a current value flowing though the heater 35 from the sensor 103 so as to determine a current resistance value of the heater 35. Accordingly, a current temperature of the heater 35 corresponding to the first heater 35A may be estimated.

Thus, the controller 102 may calculate an exact temperature of the heater 35. By determining the exact temperature of the heater 35, the controller 102 may perform more precise control for various components (see step S4 in FIG. 7).

For example, the controller 102 may control the temperature of the heater 35 based on the calculated temperature of the heater 35. The controller 102 may control a voltage applied to the heater 35 to increase or decrease a heating temperature of the heater 35, thereby adjusting the temperature of the heater 35 to a target temperature. As another example, based on the current temperature of the heater 35, the controller 102 may determine whether liquid stored in a cartridge (not shown) is exhausted. As another example, the controller 102 may control the user interface to provide a user with information regarding the current temperature of the heater 35.

The memory 37 may store therein identification information for identifying whether the heater module 30 is authentic (real). When the heater module 30 is coupled to the body 10, the controller 102 may receive identification information stored in the memory 37 to determine whether the heater module 30 is authentic. For example, the controller 102 may compare embedded information with the identification information to determine whether the heater module 30 is authentic. For example, the memory 37 may store identification information regarding the heater module 30 in the form of an encrypted code, and the controller 102 may decode the encrypted code to determine whether the heater module 30 is authentic.

For example, when the heater module 30 is fake, the controller 102 may cut off power supply to the heater 35, whereas when the heater module 30 is real, the controller 102 may control such that power is supplied to the heater 35. The controller 102 may control the user interface to provide a user with information on whether the heater module 30 is authentic.

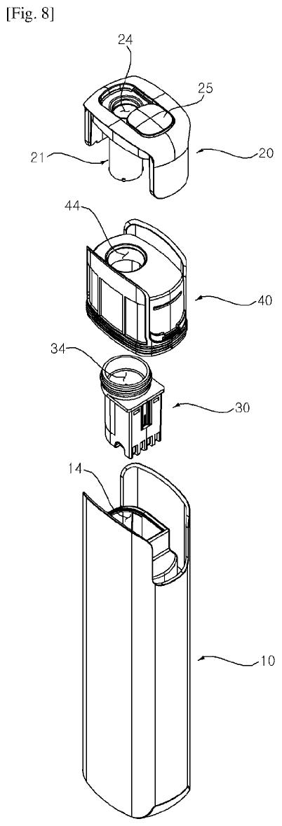

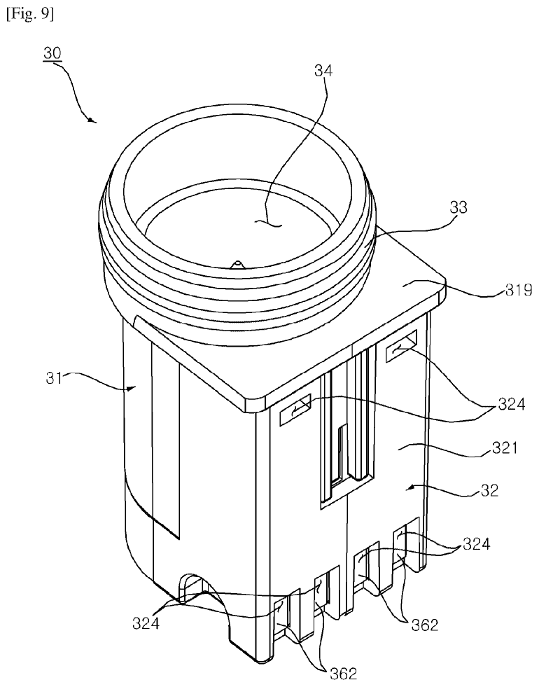

Referring to FIGS. 8 and 9, the heater module 30 may be detachably inserted into the first insertion space 14 that is open at the top in the upper portion of the body 10. By removing the inner cover 40 from the body 10, the heater module 30 may be separated from the first insertion space 14. After removing the heater module 30 from the inner cover 40, a user may couple a new heater module 30 to the inner cover 40 and then couple the inner cover 40 to the body 10, so that the heater module 30 may be seated or placed in the first insertion space 14. Accordingly, the heater module 30 may be easily removed, replaced, and assembled.

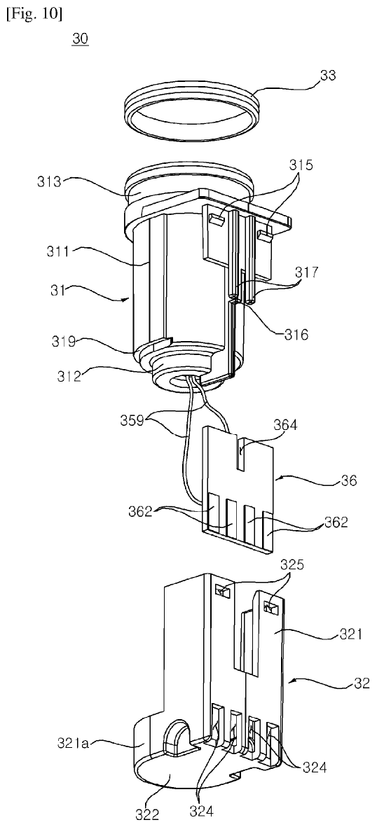

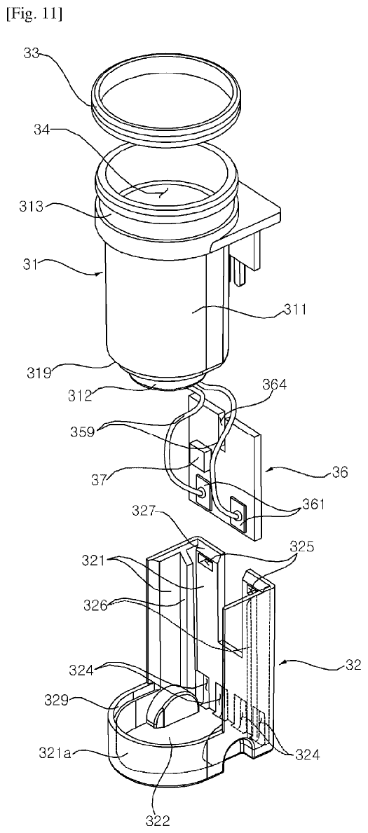

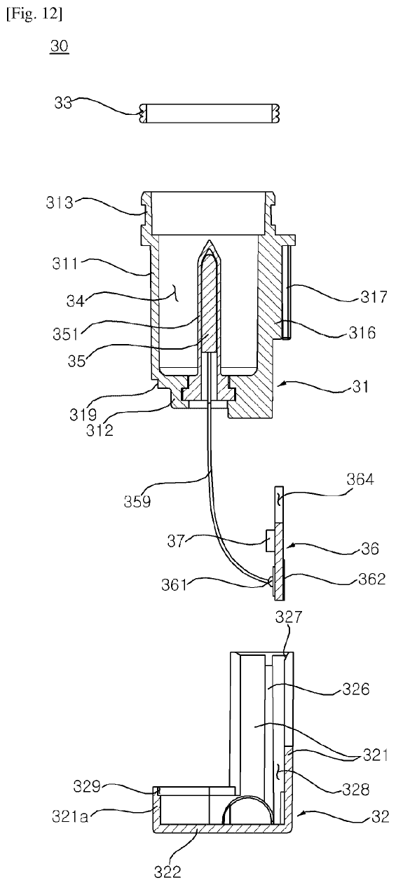

Referring to FIGS. 9 to 11, the heater module 30 may include a heater holder 31. The heater holder 31 may include a vertically elongated pipe shape. The heater holder 31 may have therein a second insertion space 34 open at top. The second insertion space 34 may be formed in a cylindrical shape extending vertically. The heater 35 may be fixed to the heater holder 31 (see FIG. 12).

The heater module 30 may include a frame 32. The frame 32 may be coupled to the heater holder 31. A lateral wall (or lateral portion) 321 of the frame 32 may cover one lateral wall (or lateral portion) 311 of the heater holder 31. The lateral wall 321 of the frame 32 may be elongated vertically. The lateral wall 321 of the frame 32 may have a bent ‘U’ shape. A lower portion 322 of the frame 32 may cover a lower portion 312 of the heater holder 31.

A mount wall 321a may extend upward from a circumference of the lower portion 322 of the frame 32. The mount wall 321a may be connected to the lateral wall 321 of the frame 32. The mount wall 321a may be connected to the lateral wall 311 of the heater holder 31. The mount wall 321a may cover one side of the lower portion 312 of the heater holder 31.

The memory 37 may be mounted on a second substrate 36. The second substrate 36 may be disposed between the heater holder 31 and the frame 32. The second substrate 36 may be coupled or fixed to the frame 32. For example, the second substrate 36 may have a flat plate shape as shown in the drawings.

The second substrate 36 may be disposed between the lateral wall 311 of the heater holder 31 and the lateral wall 321 of the frame 32. The second substrate 36 may be disposed parallel to a vertical or up-and-down direction. The second substrate 36 may be parallel to the lateral wall 311 of the heater holder 31 and the lateral wall 321 of the frame 32.

The frame 32 may have a slot 328. The second substrate 36 may be inserted into the slot 328. The slot 328 may be formed in the lateral wall 321 of the frame 32. The slot 328 may extend in the vertical direction. The slot 328 may be open at top. The second substrate 36 may be vertically disposed in the slot 328. The second substrate 36 may be inserted downward into the slot 328.

An insertion guide surface 327 may be formed in the vicinity of the opening of the slot 328 in an inclined manner toward the slot 328. For example, the slot 328 may open at the top, and the insertion guide surface 327 may be inclined downward toward the slot 328. The insertion guide surface 327 may be formed at an upper end surface of the lateral wall 321 of the frame 32. The insertion guide surface 327 may guide insertion of the second substrate 36 into the slot 328. For example, during the insertion of the second substrate 36, even when the second substrate 36 collides with the lateral wall 321 of the frame 32 near the opening of the slot 328, the second substrate 36 may come into contact with the insertion guide surface 327 to thereby slide into the slot 238.

A rear surface and both edges of the second substrate 36 may be supported by the lateral wall 321 of the frame 32 in the slot 328. A front surface of the second substrate 36 may face the lateral wall 311 of the heater holder 31 in the slot 328.

The second substrate 36 may be provided with a first module terminal 361. The first module terminal 361 may be provided on the front surface of the second substrate 36. A first end of a lead wire 359 may be connected to the heater 35 and a second end of the lead wire 359 may be connected to the first module terminal 361. The lead wire 359 and the first module terminal 361 may each be provided in plurality. For example, two first module terminals 361 and two lead wires 359 may be provided. The lead wire 359 may be disposed between the heater holder 31 and the frame 32.

The second substrate 36 may be provided with a second module terminal 362. The second module terminal 362 may be provided on the rear surface of the second substrate 36. The second module terminal 362 may be provided at a lower end of the second substrate 36. The second module terminal 362 may be provided in plurality.

For example, four second module terminals 362 may be provided, so that two second module terminals 362 may be electrically connected to the heater 35, and the other two second module terminals 362 may be electrically connected to the memory 37.

The frame 32 may have a terminal hole 324. The frame 32 may be open at one side to define the terminal hole 324. For example, the terminal hole 324 may be formed as the lateral wall 321 of the frame 32 that supports the rear surface of the second substrate 36 is open. Alternatively, the terminal hole 324 may be formed as a lower corner or edge of the lateral wall 321 of the frame 32 is open. The terminal hole 324 may communicate with the slot 328. The terminal hole 324 may be provided in plurality. The terminal hole 324 may correspond to the second module terminal 362. The plurality of second module terminals 362 may be exposed to an outside of the heater module 30 through the respective plurality of terminal holes 324.

The frame 32 may have a supporter 326. The supporter 326 may protrude from the lateral wall 321 of the frame 32. The supporter 326 may be elongated vertically. The supporter 326 may support the front surface of the second substrate 36. A pair of supporters 326 may be provided to support opposite corners of the front surface of the second substrate 36. The supporter 326 and the lateral wall 321 of the frame 32 together may define the slot 328.

The frame 32 and the heater holder 31 may be coupled together in a snap-fit manner. The frame 32 may be coupled in a non-separable (or non-removable) manner to the heater holder 31. Any one of the heater holder 31 and the frame 32 may be provided with a first coupling hook 315, and the other may be provided with a first coupling groove 325 to which the first coupling hook 315 is fastened. For example, the first coupling hook 315 may protrude from the heater holder 31 in a lateral direction, and the first coupling groove 325 may be formed in the lateral wall 321 of the frame 32 at a position corresponding to the first coupling hook 315.

The second substrate 36 may have a positioning groove 364 open at top. The positioning groove 364 may be elongated vertically. The heater holder 31 may have a positioning protrusion 316. The positioning protrusion 316 may be elongated vertically, and may protrude from the lateral wall 311 of the heater holder 31 in the lateral direction. The positioning protrusion 316 may have a shape corresponding to the positioning groove 364. The positioning protrusion 316 may be fitted into the positioning groove 364, so that the second substrate 36 may be aligned or fixed in position with respect to the heater holder 31.

A first sealer 33 may be coupled to the heater module 30. The first sealer 33 may have a ring shape. The first sealer 33 may surround an upper circumference of the heater holder 31. The upper circumference of the heater holder 31 may be recessed in a radially inward direction to define a first rim portion 313. The first sealer 33 may be fitted and fixed to the first rim portion 313. The first sealer 33 may be made of a material having elasticity. For example, the first sealer 33 may be formed of a material such as rubber, silicone, or the like.

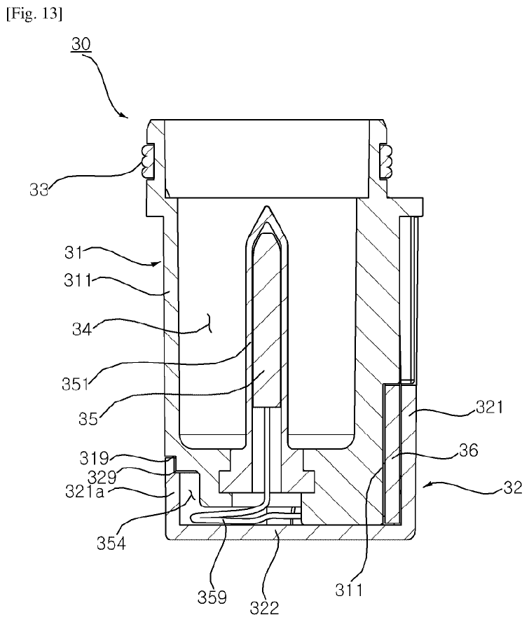

Referring to FIGS. 12 and 13, the heater 35 may include a heater rod 351. The heater rod 351 may be fixed to the lower portion 312 of the heater holder 31 so as to protrude to the second insertion space 34. The heater 35 may be inserted into the heater rod 351. The heater rod 351 may have a cavity open at bottom. The heater rod 351 may surround the heater 35. The heater rod 351 may have a cylindrical shape. The heater rod 351 may have a sharp or pointed upper end. The heater rod 351 may have high thermal expandability, excellent thermal insulation, and low thermal conductivity. The heater rod 351 may have high rigidity. For example, the heater rod 351 may be formed of zirconia. However, the material of the heater rod 351 is not limited thereto. Heat generated from the heater 35 may be transferred to the outside through the heater rod 351. When the stick S is inserted into the second insertion space 34, the heater rod 351 and the heater 35 may be disposed inside the stick S.

The lead wire 359 may extend from the heater 35 to the outside of the heater rod 351 and the heater holder 31 through a bottom opening of the heater rod 351. A first end of the lead wire 359 may be connected to the heater 35 and a second end of the lead wire 359 may be connected to the second substrate 36. The lead wire 359 may provide an electrical connection between the heater 35 and the second substrate 36. For example, the lead wire 359 may be connected to the heater 35 and the second substrate 36 by a welding process such as soldering or ultrasonic welding. The lead wire 359 may be electrically connected to the battery 101, the controller 102, and the sensor 103 through a circuit pattern printed on the second substrate 36.

Accordingly, the heater 35 may generate heat by receiving power through the lead wire 359. In addition, the sensor 103 may detect, through the lead wire 359, a value regarding the temperature of the heater 35 or a value regarding the resistance of the heater 35. The controller 102 may receive the value detected by the sensor 103. Since this has been described above, description thereof will be omitted.

The heater rod 351 may be buried into the lower portion 312 of the heater holder 31. The heater rod 351 may protrude long upward from the lower portion 312 of the heater holder 31 toward the second insertion space 34. The heater holder 31 may be insert-injected with the heater rod 351. In this case, the heater holder 31 may be injected by inserting the heater rod 351 into an injection mold and then injecting a polymer resin into the injection mold. In a state where the heater 35 and the lead wire 359 are placed in the heater rod 351, a polymer resin may be injected while the heater rod 351 is being inserted into an injection mold.

The lower portion 312 of the heater holder 31 may be spaced upward from the lower portion 322 of the frame 32 to thereby form a wire accommodating space 354. The lead wire 359 may be accommodated in the wire accommodating space 354. For example, the wire accommodating space 354 may be defined by the lower portion 312 of the heater holder 31, the lower portion 322 of the frame 32, and the mount wall 321a. A first end of the lead wire 359 that is accommodated in the wire accommodating space 354 may be connected to the lower portion side of the heater holder 31, and a second end thereof may be connected to the second substrate 36.

The mount wall 321a may be provided with an engaging projection 329. The heater holder 31 may have a recessed portion 319 in the vicinity of the lower portion 312. The recessed portion 319 may be supported by the engaging projection 329, so that the lower portion 312 of the heater holder 31 may be fixed in position with respect to the frame 32.

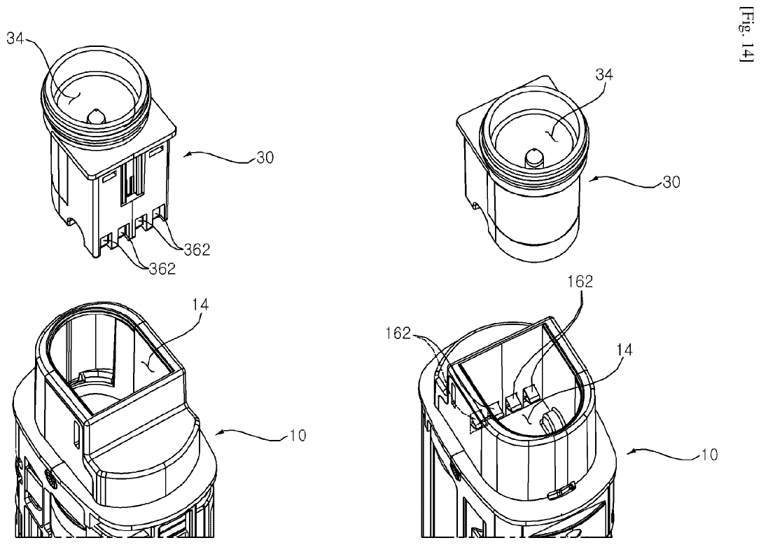

Referring to FIG. 14, the heater module 30 may be detachably inserted into the first insertion space 14. A body terminal 162 may protrude from a lower corner or edge of the first insertion space 14. The body terminal 162 may be provided at a position corresponding to the module terminal 362. When the heater module 30 is inserted into the first insertion space 14, the second module terminal 362 of the heater module 30 may come into contact with the body terminal 162 so as to be electrically connected thereto. A cross-section of the first insertion space 14 and a cross-section of the frame 32 may have non-circular shapes corresponding to each other.

Accordingly, when the heater module 30 is inserted into the first insertion space 14, the module terminal 362 and the body terminal 162 may be aligned in a set or predetermined position to be in contact with each other.

In addition, as the terminals are electrically connected to each other through lateral contact therebetween, instead of bottom contact therebetween, the heater module 30 does not receive an external force from the body terminal 162 in a direction separated from the first insertion space 14, thereby allowing the heater module 30 to be securely positioned in the first insertion space 14.

When the module terminal 362 and the body terminal 162 come into contact with each other, the memory 37 and the controller 102 may be electrically connected to each other. When the module terminal 362 and the body terminal 162 come into contact with each other, the memory 37 and the battery 101 may be electrically connected to each other. When the module terminal 362 and the body terminal 162 come into contact with each other, the heater 35 and the controller 102 may be electrically connected to each other. When the module terminal 362 and the body terminal 162 come into contact with each other, the heater 35 and the sensor 103 may be electrically connected to each other. When the module terminal 362 and the body terminal 162 come into contact with each other, the heater 35 and the battery 101 may be electrically connected to each other.

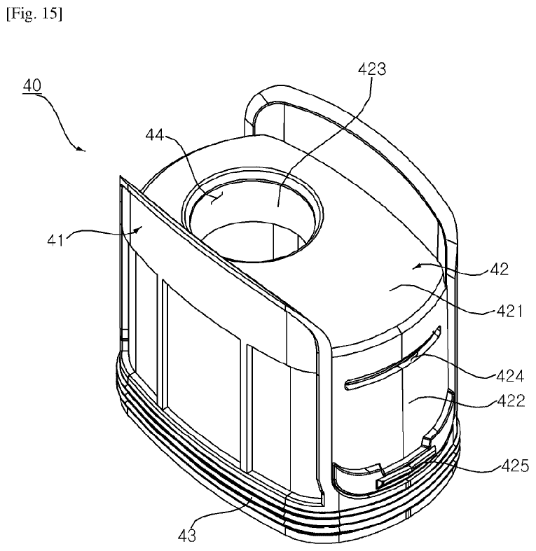

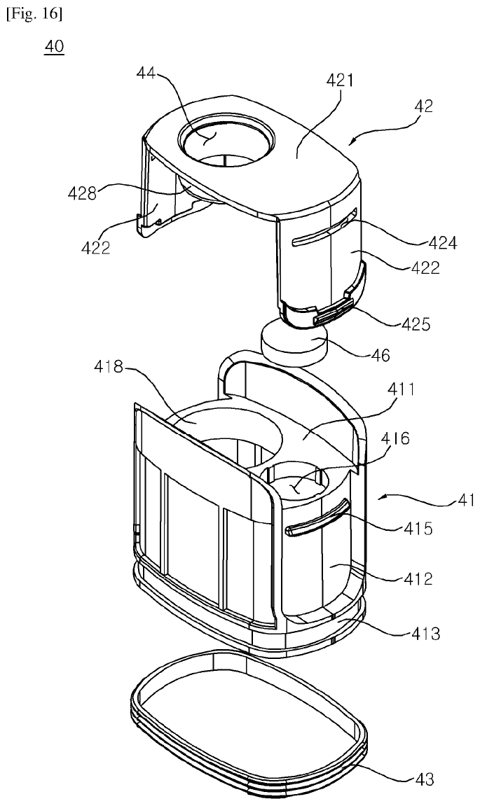

Referring to FIGS. 15 and 16, the inner cover 40 may include an inner cover body 41. The inner cover 40 may include an inner cover head 42. The inner cover head 42 may be disposed on top of the inner cover body 41 to cover the inner cover body 41.

The inner cover head 42 may include a head plate 421 and a wing 422. The head plate 421 may cover an upper portion 411 of the inner cover body 41. A pair of wings 422 may extend downward from opposite sides of the head plate 421. The pair of wings 422 may each cover a lateral portion 412 of the inner cover body 41.

The head plate 421 and the upper portion 411 of the inner cover body 41 may have an inner cover hole 44 in communication with the opening of the second insertion space 34 of the heater holder 31. A second magnet 46 may be disposed between the upper portion 411 of the inner cover body 41 and the head plate 421.

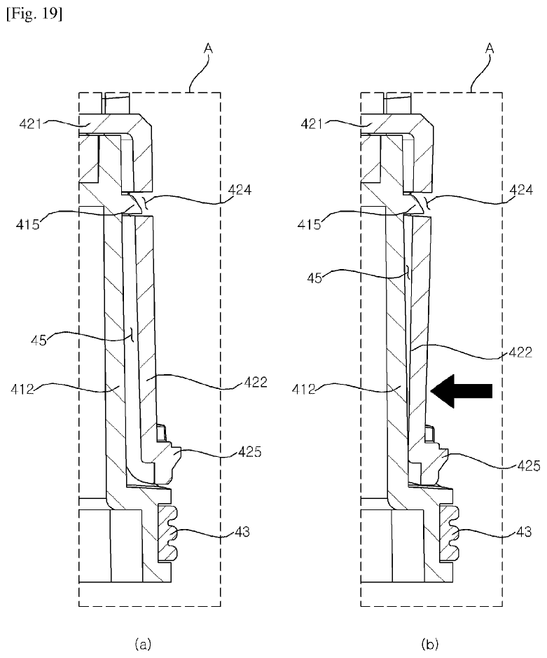

The wing 422 may have a second coupling hook 425. The second coupling hook 425 may protrude outward from the wing 422. The second coupling hook 425 may be provided at a lower portion of the wing 422. The second coupling hook 425 may be fastened to a second coupling groove 15 formed in the body 10, so as to couple the inner cover 40 to the body 10 (see FIG. 19).

The wing 422 may have a third coupling groove 424. The third coupling groove 424 may be formed above the second coupling hook 425. The wing 422 may be open inwardly or open inwardly and outwardly to define the third coupling groove 424. A third coupling hook 415 protruding from the lateral portion 412 of the inner cover body 41 may be fastened to the third coupling groove 424, so as to couple the inner cover head 42 to the inner cover body 41.

A second sealer 43 may be coupled to the inner cover 40. The second sealer 43 may have a ring shape. The second sealer 43 may surround a lower circumference of the inner cover body 41. The lower circumference of the inner cover body 41 may be recessed in the radially inward direction to define a second rim portion 413. The second sealer 43 may be fitted and fixed to the second rim portion 413. The second sealer 43 may be made of a material having elasticity. For example, the second sealer 43 may be formed of a material such as rubber, silicone, or the like.

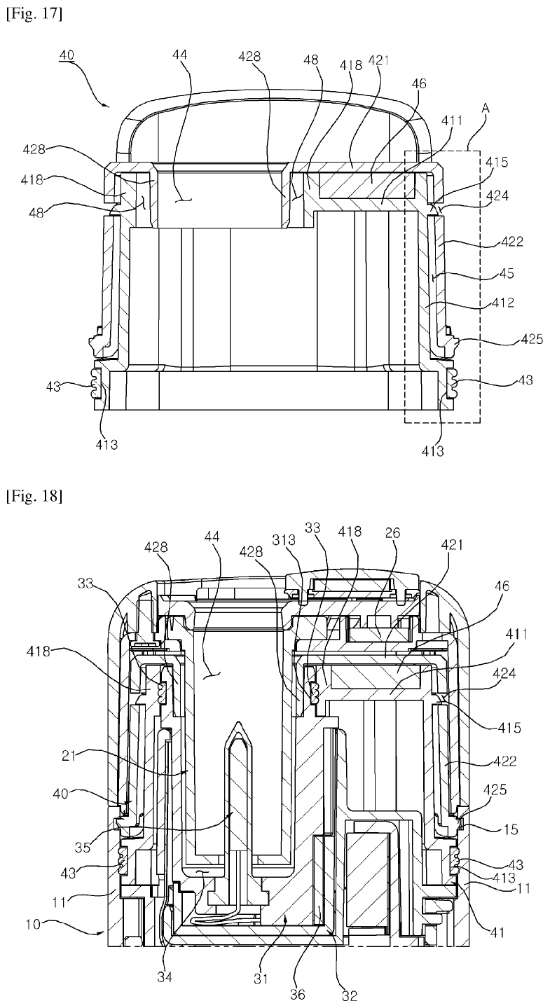

Referring to FIGS. 16 and 17, a first collar 418 may be formed at the upper portion 411 of the inner cover body 41. A second collar 428 may be formed at the head plate 421. The second collar 428 may surround the inner cover hole 44. The second collar 428 may extend downward from the head plate 421. The second collar 428 may be inserted into a space surrounded by the first collar 418. The first collar 418 may surround the second collar 428. The first collar 418 may be spaced apart from a circumference of the second collar 428 in a radially outward direction. A holder groove 48 may be defined by the first collar 418, the second collar 428, and the head plate 421. The holder groove 48 may be formed between the first collar 418 and the second collar 428. The holder groove 48 may be open at bottom.

Referring to FIG. 18, an upper end portion of the heater holder 31 may be inserted and fitted into the holder groove 48. An outer circumferential surface of the upper end portion of the heater holder 31 may be supported by the first collar 418 in the holder groove 48, and an inner circumferential surface of the upper end portion of the heater holder 31 may be supported by the second collar 428 in the holder groove 48. The upper end portion of the heater holder 31 may be fitted into the holder groove 48 so as to be detachably coupled to the inner cover 40.

The first sealer 33 may seal between the heater holder 31 and the inner cover 40. The first sealer 33 may be in close contact with the first rim portion 313 and the second collar 418 in the holder groove 48, so as to seal between the first rim portion 313 and the second collar 418. Due to the elasticity of the first sealer 33, the heater holder 31 may be detachably coupled to the inner cover 40.

The second sealer 43 may seal between the body 10 and the inner cover 40. A lateral wall 11 of the body 10 may extend upward so as to cover a lower lateral surface of the inner cover body 41 and a lower portion of the wing 422. The second sealer 43 may be in close contact with the second rim portion 413 and an inner surface of the lateral wall 11 of the body 10, so as to seal between the second rim portion 413 and the lateral wall 11 of the body 10.

Accordingly, foreign matter such as liquid may be prevented from being introduced into the heater module 30 from the third insertion space 24 and the second insertion space 34 to thereby avoid contact with the second substrate 36 or the lead wire 359, allowing a failure or malfunction to be suppressed.

Referring to FIGS. 18 and 19, the second coupling groove 15 may be open inwardly from the lateral wall 11 of the body 10. The second coupling hook 425 may be fastened to the second coupling groove 15, so as to couple the inner cover 40 to the body 10.

The wing 422 may be configured to pivot in and out, with respect to the head plate 421. The wing 422 and the lateral portion 412 of the inner cover body 41 may be spaced apart to define a pivot space 45 for allowing the wing 422 to pivot. The wing 422 may be pivoted in a direction toward the lateral portion 412 of the inner cover body 41 or a direction away from the lateral portion 412 of the inner cover body 41. A user may press the pair of wings 422 inward with his or her hand to cause the pair of wings 422 to pivot. When the user takes his or her hand off from the pair of wings 422, the pair of wings 422 may be pivoted to return to the original position.

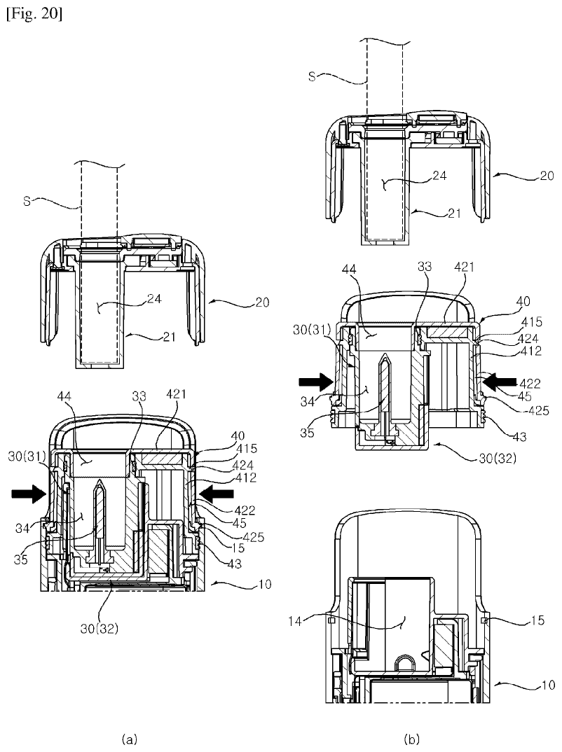

As the user presses the wing 422 inward to cause the wing 422 to pivot, the second coupling hook 425 may be separated from or couped to the second coupling groove 15, thereby allowing the inner cover 40 to be easily separated from or coupled to the body 10 (see FIG. 20). In addition, this may allow the user to easily remove or replace the heater module 30 (see FIG. 20).

The second coupling hook 425 may be inclined upward so as to gradually protrude outward toward an upper side thereof. An upper end of the second coupling hook 425 may extend horizontally.

Thus, when the inner cover 40 is pressed downward toward the body 10, the second coupling hook 425 may slide onto the lateral wall 11 of the body 10, and the wing 422 may be pivoted inwardly, allowing the inner cover 40 to be more easily coupled to the body 10 to thereby improve the ease of assembly. In addition, since the inner cover 40 is not separated from the body 10 unless the wing 422 is pivoted, structural stability may be achieved.

The third coupling hook 415 may be inclined downward so as to gradually protrude outward toward a lower side thereof. A lower end of the third coupling hook 415 may extend horizontally.

Thus, when the inner cover head 42 is pressed to a lower side of the inner cover body 41, a lower end of the wing 422 may move downward while sliding onto the third coupling hook 415, and the third coupling hook 415 may be inserted into the coupling groove 424, thereby improving the ease of assembly. In addition, since the inner cover head 42 is not separated upward from the inner cover body 41, structural stability may be achieved.

Referring to FIGS. 1 to 20, an aerosol generating device according to an aspect of the present disclosure includes: a body comprising a first opening to a first insertion space; a heater module configured to be removably inserted into the first insertion space, wherein the heater module comprises: a heater holder comprising a second opening to a second insertion space, wherein a heater is disposed in the second insertion space, a frame coupled to the heater holder, and a substrate coupled to the frame and on which a memory configured to store unique information regarding the heater is mounted; and a controller disposed in the body and configured to control operation of the heater based on receiving the unique information regarding the heater from the memory.

According to another aspect of the present disclosure, the frame may comprise a slot configured to accommodate insertion of the substrate.

According to another aspect of the present disclosure, the slot may be formed at a lateral portion of the frame covering a lateral portion of the heater holder, wherein the substrate may be inserted at a top opening of the slot to face the lateral portion of the heater holder.

According to another aspect of the present disclosure, the frame may comprise an insertion guide surface at a vicinity of the opening of the slot and having an angled surface so as to guide insertion of the substrate into the slot.

According to another aspect of the present disclosure, the slot may be defined by a supporter elongated between the heater holder and a side of the frame to secure the substrate.

According to another aspect of the present disclosure, there may further be provided a lead wire electrically connecting the heater and the substrate to each other, wherein the lead wire is disposed between the heater holder and the frame.

According to another aspect of the present disclosure, the frame may comprise a lower portion that supports a lower portion of the heater holder. The lead wire may be accommodated between the lower portion of the heater holder and the lower portion of the frame.

According to another aspect of the present disclosure, the substrate may comprise a positioning groove indented at a top of the substrate, and the heater holder may comprise a positioning protrusion configured to be inserted into the positioning groove to align a position of the substrate.

According to another aspect of the present disclosure, the aerosol generating device may further include: a terminal hole formed at a lower end of a lateral portion of the frame and configured to allow a module terminal provided on the substrate to be exposed therethrough; and a lead wire having a first end connected to the heater and a second end connected to a second surface of the substrate, wherein a body terminal disposed at a lower portion of the first insertion space is configured to contact the module terminal exposed through the terminal hole when the heater module is inserted into the first insertion space.

According to another aspect of the present disclosure, the module terminal may include a first module terminal connected to the heater; and a second module terminal connected to the memory.

According to another aspect of the present disclosure, the first opening may be non-circular and corresponds to a cross section shape of the frame to allow insertion of the frame into the first opening.

According to another aspect of the present disclosure, the aerosol generating device may further include: a first coupling groove formed at one of the heater holder or the frame; and a first coupling hook formed at another one of the heater holder or the frame such that the first coupling hook is configured to engage the first coupling groove to secure the heater holder and the frame together.

According to another aspect of the present disclosure, the aerosol generating device may further include an inner cover detachably coupled to an upper portion of the body to cover the upper portion of the body and the heater holder, wherein the inner cover comprises an insertion hole corresponding to the second insertion space, wherein the heater holder is detachably coupled to the inner cover.

According to another aspect of the present disclosure, the aerosol generating device may further include a first sealer to provide a seal between the heater holder and the inner cover; and a second sealer to provide a seal between the inner cover and the body.

According to another aspect of the present disclosure, the inner cover may comprise a holder groove configured to receive insertion of an upper end of the heater holder, and wherein the first sealer extends along an outer circumferential surface of the upper end of the heater holder to provide a seal between the heater holder and the inner cover inserted in the holder groove.

According to another aspect of the present disclosure, the inner cover may include: a head plate covering the upper portion of the body and an upper portion of the heater holder and formed to define the insertion hole; and a pair of wings extending downward from opposite sides of the head plate to cover respective lateral sides of the upper portion of the body and respective lateral portions of the heater holder, wherein the pair of wings are configured to be detachably coupled to the body.

According to another aspect of the present disclosure, an upper portion of the body comprises a pair of second coupling grooves formed at inward facing lateral walls, wherein the pair of wings each comprise a second coupling hook protruding outward and configured to engage with a corresponding second coupling groove, and wherein the pair of wings are configured to pivot inwardly with respect to the inner cover head plate to allow the second coupling hooks to disengage from the second coupling grooves.

According to another aspect of the present disclosure, an outer surface of each second coupling hook is angled inward with respect to a downward direction.

According to another aspect of the present disclosure, the wing may comprise a pair of third coupling grooves respectively formed above the second coupling hooks, and wherein the inner cover comprises an inner cover body disposed under the inner cover head and covered by the wing, and wherein the inner cover comprises a pair of third coupling hooks protruding outward from a lateral portion of the inner cover body and configured to respectively engage with the third coupling grooves.

According to another aspect of the present disclosure, the aerosol generating device may further include a second sealer to provide a seal between the inner cover and the inner cover body.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body comprising a first opening to a first insertion space;
a heater module configured to be removably inserted into the first insertion space, wherein the heater module comprises:
a heater holder comprising a second opening to a second insertion space, wherein a heater is disposed in the second insertion space,
a frame coupled to the heater holder, and
a substrate coupled to the frame and on which a memory configured to store unique information regarding the heater is mounted; and
a controller disposed in the body and configured to control operation of the heater based on receiving the unique information regarding the heater from the memory.

2. The aerosol generating device of claim 1, wherein the frame comprises a slot configured to accommodate insertion of the substrate.

3. The aerosol generating device of claim 2, wherein the slot is formed at a lateral portion of the frame covering a lateral portion of the heater holder,
wherein the substrate is inserted at a top opening of the slot to face the lateral portion of the heater holder.

4. The aerosol generating device of claim 3, wherein the frame comprises an insertion guide surface at a vicinity of the opening of the slot and having an angled surface so as to guide insertion of the substrate into the slot.

5. The aerosol generating device of claim 3, wherein the slot is defined by a supporter elongated between the heater holder and a side of the frame to secure the substrate.

6. The aerosol generating device of claim 5, further comprising a lead wire electrically connecting the heater and the substrate to each other,
wherein the lead wire is disposed between the heater holder and the frame,
wherein the frame comprises a lower portion that supports a lower portion of the heater holder, and
wherein the lead wire is accommodated between the lower portion of the heater holder and the lower portion of the frame.

7. The aerosol generating device of claim 3, wherein the substrate comprises a positioning groove indented at a top of the substrate, and
wherein the heater holder comprises a positioning protrusion configured to be inserted into the positioning groove to align a position of the substrate.

8. The aerosol generating device of claim 1, further comprising:
a terminal hole formed at a lower end of a lateral portion of the frame and configured to allow a module terminal provided on the substrate to be exposed therethrough; and
a lead wire having a first end connected to the heater and a second end connected to a second surface of the substrate,
wherein a body terminal disposed at a lower portion of the first insertion space is configured to contact the module terminal exposed through the terminal hole when the heater module is inserted into the first insertion space.

9. The aerosol generating device of claim 8, wherein the first opening is non-circular and corresponds to a cross section shape of the frame to allow insertion of the frame into the first opening.

10. The aerosol generating device of claim 1, further comprising:
a first coupling groove formed at one of the heater holder or the frame; and
a first coupling hook formed at another one of the heater holder or the frame such that the first coupling hook is configured to engage the first coupling groove to secure the heater holder and the frame together.

11. The aerosol generating device of claim 1, further comprising an inner cover detachably coupled to an upper portion of the body to cover the upper portion of the body and the heater holder,
wherein the inner cover comprises an insertion hole corresponding to the second insertion space,
wherein the heater holder is detachably coupled to the inner cover.

12. The aerosol generating device of claim 11, further comprising:
a first sealer configured to provide a seal between the heater holder and the inner cover; and
a second sealer configured to provide seal between the inner cover and the body,
wherein the inner cover comprises a holder groove configured to receive insertion of an upper end of the heater holder, and
wherein the first sealer extends along an outer circumferential surface of the upper end of the heater holder to provide a seal between the heater holder and the inner cover inserted in the holder groove.

13. The aerosol generating device of claim 11, wherein the inner cover comprises:
a head plate covering the upper portion of the body and an upper portion of the heater holder and formed to define the insertion hole; and
a pair of wings extending downward from opposite sides of the head plate to cover respective lateral sides of the upper portion of the body and respective lateral portions of the heater holder,
wherein the pair of wings are configured to be detachably coupled to the body.

14. The aerosol generating device of claim 13, wherein an upper portion of the body comprises a pair of second coupling grooves formed at inward facing lateral walls,
wherein the pair of wings each comprise a second coupling hook protruding outward and configured to engage with a corresponding second coupling groove, and
wherein the pair of wings are configured to pivot inwardly with respect to the inner cover head plate to allow the second coupling hooks to disengage from the second coupling grooves,
wherein an outer surface of each second coupling hook is angled inward with respect to a downward direction.

15. The aerosol generating device of claim 14, wherein the wing further comprises a pair of third coupling grooves respectively formed above the second coupling hooks, and
wherein the inner cover comprises an inner cover body disposed under the inner cover head and covered by the wing, and
wherein the inner cover comprises a pair of third coupling hooks protruding outward from a lateral portion of the inner cover body and configured to respectively engage with the third coupling grooves, and
further comprising a second sealer configured to provide a seal between the inner cover and the inner cover body.
